(19) United States
(12) Patent Application Publication
(10) Pub. No.: US 2008/0170935 A1
(43) Pub. Date: Jul. 17, 2008

(54) AXIAL-FLOW FAN

(75) Inventors: Toshiyuki Nakamura, Nagano (JP); Shigekazu Mitomo, Nagano (JP); Atsushi Yanagisawa, Nagano (JP)

Correspondence Address: RANKIN, HILL & CLARK LLP, 38210 Glenn Avenue, WILLOUGHBY, OH, 44094-7808, US

(73) Assignee: SANYO DENKI CO., LTD., Tokyo (JP)

(21) Appl. No.: 12/014,436

(22) Filed: Jan. 15, 2008

(30) Foreign Application Priority Data
Jan. 16, 2007 (JP) 2007-007322
Jan. 9, 2008 (JP) 2008-002510

(51) Int. Cl. F01D 25/04; F04D 19/00; F01D 25/16; H02K 7/14

(52) U.S. Cl. 415/119; 310/67 R; 310/90; 310/51; 310/89; 415/229; 415/220

(57) ABSTRACT

When it is assumed that a thickness of a stator core is TSt as measured in parallel with an axial direction of a rotary shaft and a thickness of the fan housing is TFr as measured in parallel with the axial direction, a ratio of TSt/TFr is defined as 8% to 25%. With this arrangement, among frequency components included in vibration to be carried to the fan housing when a rotor is rotated, an over-all value of frequency components caused by cogging torque becomes smaller than an over-all value of frequency components caused by unbalance of the rotor. As a result, the vibration to be carried to the fan housing when a rotor is rotated may be restrained, in particular, when the rotor is rotated at a low speed.

### BACKGROUND OF THE INVENTION

The present invention relates to an axial-flow fan used for cooling an electrical component or the like.

Japanese Patent Publication No. 05-164089 (hereinafter referred to as Patent Document 1) discloses an axial-flow fan including a fan housing, an impeller having a plurality of blades, a rotor, a stator, and a motor case. The rotor includes a rotary shaft and a plurality of rotor magnetic poles which are formed of permanent magnets and disposed in a circumferential direction of the rotary shaft, and is fixed to the impeller. The stator includes a stator core and exciting windings. The stator core includes a plurality of stator magnetic poles facing the rotor magnetic poles in a radial direction of the rotary shaft. The exciting windings are respectively wound around the stator magnetic poles. The motor case includes a bearing supporting cylindrical portion. Inside the bearing supporting cylindrical portion, bearings that support the rotary shaft of the rotor are arranged. The stator core is formed with a through hole into which the bearing supporting cylindrical portion is fitted. The stator is fixed to the bearing supporting cylindrical portion with the bearing supporting cylindrical portion fitted into this through hole.

In the axial-flow fan of this type disclosed in Patent Document 1, vibration generated when the rotor is rotated is carried to or reaches the fan housing. For this reason, an increase of the vibration causes noise. In the conventional axial-flow fan, when the number of rotations for the rotor is small, or the rotor is rotated at a low speed, the vibration that reaches the fan housing increases.

### SUMMARY OF THE INVENTION

An object of the present invention is therefore to provide an axial-flow fan capable of restraining vibration to be carried to a fan housing, over an entire speed range of a rotor.

An axial-flow fan, of which improvement is aimed at by the present invention, comprises a fan housing, an impeller, a rotor, a stator, a motor case, and bearings. The fan housing includes an air channel having two openings, one opening and the other opening. The impeller is disposed inside the air channel and includes a plurality of blades. The rotor includes a rotary shaft and a plurality of rotor magnetic poles constituted from permanent magnets. The rotor magnetic poles are disposed in a circumferential direction of the rotary shaft. The impeller is fixed to the rotor. The stator includes a stator core having a plurality of stator magnetic poles, and exciting windings respectively wound around the stator magnetic poles. The stator magnetic poles face the rotor magnetic poles in a radial direction of the rotary shaft. The motor case includes a bottom wall portion located on a side of the one opening, a peripheral wall portion formed continuously with the bottom wall portion and extending toward the other opening, and a bearing supporting cylindrical portion provided at the bottom wall portion and extending toward the other opening. The bearings are disposed inside the bearing supporting cylindrical portion and support the rotary shaft. The stator core is formed with a through hole into which the bearing supporting cylindrical portion is fitted. The stator is fixed to the bearing supporting cylindrical portion with the bearing supporting cylindrical portion fitted into the through hole.

In the present invention, the rotor, stator, impeller, fan housing, and motor case are constituted so that, among a plurality of frequency components included in vibration that is carried to the fan housing when the rotor is rotated, an over-all value (O. A.) of a plurality of frequency components caused by cogging torque (hereinafter referred to as cogging torque frequency components) becomes smaller than an over-all value (O. A.) of a plurality of frequency components caused by unbalance of the rotor (hereinafter referred to as unbalance frequency components). The “over-all value of the cogging torque frequency components (O.A [f(m*n)]) ” is herein defined to be a synthesized value of frequency spectra of the cogging torque frequency components among the frequency components obtained by frequency analysis of the vibration. The “over-all value of the unbalance frequency components (O.A [f(n)])n is herein defined to be a synthesized value of frequency spectra of the unbalance frequency components among the frequency components obtained by the frequency analysis of the vibration. “The total over-all value” is a sum of the over-all value of cogging torque frequency components and the over-all value of unbalance frequency components.

The inventors have studied vibration that is carried to or reaches the fan housing when the rotor is rotated, and have noticed that: when a compact axial-flow fan of which the fan housing has a side of 8 cm is rotated at a high speed equal to or more than 2500 rpm, the over-all value of cogging torque frequency components is smaller than the over-all value of unbalance frequency components. When the compact axial-flow fan is rotated at a low speed less than 2500 rpm, the over-all value of cogging torque frequency components is larger than the over-all value of unbalance frequency components. Then, the inventors have found that the larger the over-all value of cogging torque frequency components at low-speed rotation is, the more the vibration carried to the fan housing increases. Accordingly, in the present invention, the rotor, stator, impeller, fan housing, and motor case are constituted so that, among the frequency components included in the vibration that is carried to the fan housing when the rotor is rotated, the over-all value of cogging torque frequency components becomes smaller than the over-all value of unbalance frequency components. As a result, over an entire speed range including low-speed and high-speed rotation regions, vibration of the motor may effectively be restrained.

Some approaches for making the over-all value of cogging torque frequency components smaller than the over-all value of unbalance frequency components may be conceived. Supposing that a thickness of the stator core is defined to be TSt as measured in a direction parallel to an axial direction of the rotary shaft, and a thickness of the fan housing is defined to be TFr as measured in the direction parallel to the axial direction, shapes and dimensions of the stator and fan housing are defined so that the ratio of TSt/TFr may take a value of 8% to 25%. When the ratio of TSt/TFr exceeds 25%, the over-all value of cogging torque frequency components tends to be larger than the over-all value of unbalance frequency components at low-speed rotation of the axial-flow fan. When the ratio of TSt/TFr falls below 8%, an output of the motor is reduced, which will leads to augmented power consumption, increased vibration, and starting failure of the axial-flow fan.

Under these circumstances, balance between the rotor and the stator should be taken into consideration. When a thickness of the rotor magnetic pole of the rotor is defined to be TMg as measured in the direction parallel to the axial direction, it is preferable that the ratio of TSt/TMg may take a value of 40% to 70%.

Further, an amount of air that passes through the air channel should be taken into consideration. When a minimum inside diameter of the air channel is defined to be Rmin and an outside diameter of the motor case is defined to be Rm, it is preferable that the fan housing and the peripheral wall portion may be connected by four webs and that the ratio of Rm/Rmin may take a value of 35% to 55%.

When the bearings are constituted from a pair of ball bearings disposed inside the bearing supporting cylindrical portion, and the ball bearings in the pair are arranged at an interval in the axial direction, it is preferable to arrange the stator core and the pair of ball bearings so that a mounting position of the stator core on the bearing supporting cylindrical portion may be located between positions of the pair of ball bearings disposed inside the bearings supporting cylindrical portion. With this arrangement, vibration generated from the stator is distributed and then carried to the pair of bearings. Further, the vibration generated by rotation of the rotor is not readily combined with the vibration generated from the stator. Accordingly, large vibration is not readily generated locally. Thus, vibration may be reduced and service life of the ball bearings may be extended.

According to the present invention, the rotor, stator, impeller, fan housing, and motor case are constituted so that, among the frequency components included in vibration to be carried to the fan housing when the rotor is rotated, the over-all value of cogging torque frequency components becomes smaller than the over-all value of unbalance frequency components. Accordingly, over the entire speed range of the rotor including the low-speed and high-speed rotation regions, vibration of the motor may effectively be restrained.

### BRIEF DESCRIPTION OF THE DRAWINGS

These and other objects and many of the attendant advantages of the present invention will be readily appreciated as the same becomes better understood by reference to the following detailed description when considered in connection with the accompanying drawings.

FIG. 1A is a front view of an axial-flow fan of an embodiment of the present invention.

FIG. 1B is a side view of the axial-flow fan of the embodiment of the present invention.

FIG. 1C is a back view of the axial-flow fan of the embodiment of the present invention.

FIG. 2 is a cross-sectional view of the axial-flow fan of the embodiment of the present invention.

FIG. 3A is a graph showing a relationship between a frequency and acceleration of vibration of the axial-flow fan of the embodiment when the axial-flow fan of the embodiment is rotated at a low speed of 1,900 rpm.

FIG. 3B is a graph showing a relationship between a frequency and acceleration of vibration of an axial-flow fan of a comparative example when the axial-flow fan of the comparative example is rotated at the low speed of 1,900 rpm.

FIG. 4A is a graph showing a relationship between a frequency and acceleration of vibration of the axial-flow fan of he embodiment when the axial-flow fan of the embodiment is rotated at a high speed of 3,800 rpm.

FIG. 4B is a graph showing a relationship between a frequency and acceleration of vibration of the axial-flow fan of the comparative example when the axial-flow fan of the comparative example is rotated at the high speed of 3,800 rpm.

FIG. 5 is a graph showing results of measurement which studied the following relationships when a thickness of a stator core is defined to be TSt as measured in parallel with an axial direction of a rotary shaft, a thickness of a fan housing is defined to be TFr as measured in parallel with the axial direction, and the ratio of TSt/TFr is varied: relationships between the ratio of TSt/TFr and the ratio of cogging torque components to the total over-all value, and relationships between the ratio of TSt/TFr and the ratio of the over-all value of unbalance frequency components to the total over-all value when the axial-flow fan of the embodiment is rotated at the low speed of 1,900 rpm, as well as relationships between the ratio of TSt/TFr and the ratio of the over-all value of cogging torque components to the total over-all value, and relationships between the ratio of TSt/TFr and the ratio of the over-all value of unbalance frequency components to the total over-all value when the axial-flow fan of the embodiment is rotated at the high speed of 3,800 rpm.

FIG. 6 is a graph showing results of measurement which studied the following relationships when a thickness of the stator core is defined to be TSt as measured in parallel with an axial direction of the rotary shaft, a thickness of a rotor magnetic pole of a rotor is defined to be TMg as measured in parallel with the axial direction, and the ratio of TSt/TFr is varied: relationships between the ratio of TSt/TMg and the ratio of the over-all value of cogging torque frequency components to the total over-all value, and relationships between the ratio of TSt/TMg and the ratio of the over-all value of unbalance frequency components to the total over-all value when the axial-flow fan was rotated at the low speed of 1,900 rpm, as well as relationships between the ratio of TSt/TMg and the ratio of the over-all value of cogging torque frequency components to the total over-all value, and relationships between the ratio of TSt/TMg and the ratio of the over-all value of unbalance frequency components to the total over-all value when the axial-flow fan was rotated at the high speed of 3,800 rpm.

FIG. 7 is a graph showing results of measurement which studied the following relationships when an outside diameter of a motor case is defined to be Rm, a minimum inside diameter of an air channel is defined to be Rmin, and the ratio of Rm/Rmin is varied: relationships between the ratio of Rm/Rmin and the ratio of the over-all value of cogging torque frequency components to the total over-all value, and relationships between the ratio of Rm/Rmin and the ratio of the over-all value of unbalance frequency components to the total over-all value when the axial-flow fan was rotated at the low speed of 1,900 rpm, as well as relationships between the ratio of Rm/Rmin and the ratio of the over-all value of cogging torque frequency components to the total over-all value, and relationships between the ratio of Rm/Rmin and the ratio of the over-all value of unbalance frequency components to the total over-all value when the axial-flow fan was rotated at the high speed of 3,800 rpm.

FIGS. 8A, 8B, and 8C are graphs respectively showing results of measurement which studied relationships of TSt/TFr, TSt/TMg, and Rm/Rmin ratios with vibration acceleration of the fan housing.

### DETAILED DESCRIPTION OF PREFERRED EMBODIMENT

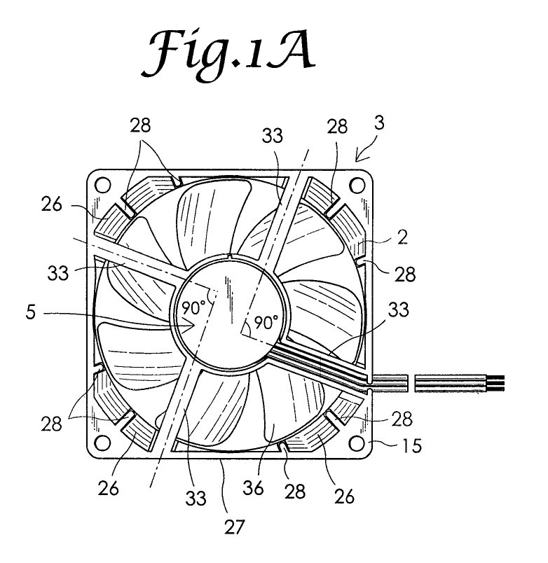

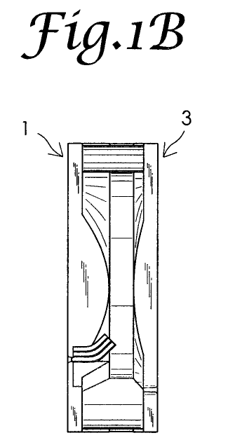

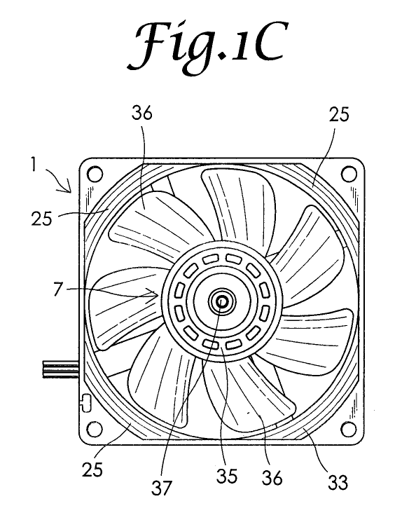

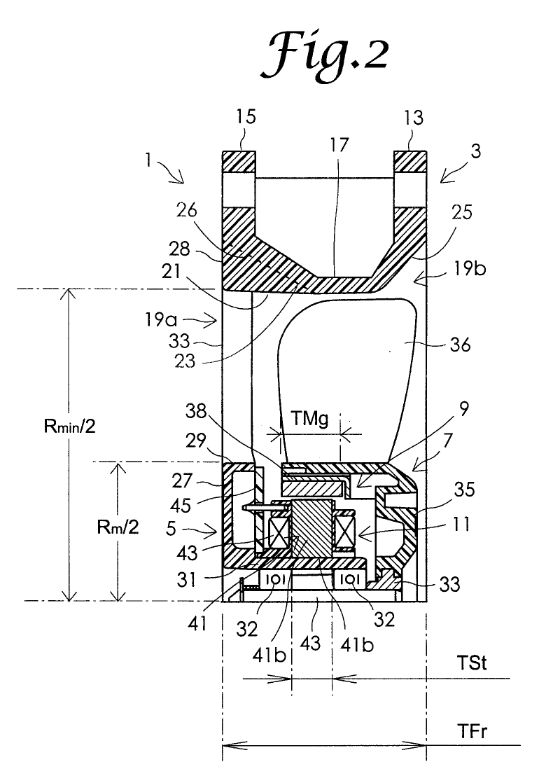

An axial-flow fan of an embodiment of the present invention will be described below in detail with reference to the drawings. FIGS. 1A to 1C are respectively a front view, a side view, and a back view of the axial-flow fan of the embodiment of the present invention. FIG. 2 is a cross-sectional view of the axial-flow fan of the embodiment of the present invention. Referring to FIGS. 1 and 2, an axial-flow fan 1 comprises a fan housing 3, a motor case 5, an impeller 7, a rotor 9, and a stator 11. The fan housing 3 includes an annular suction-side flange 13 on one side of an axial direction of a rotary shaft 37 which will be described later, and an annular discharge-side flange 15 on the other side of the axial direction. In this embodiment, one side of the fan housing is 8 cm in length. The fan housing 3 includes a cylindrical portion 17 between the flanges 13 and 15. An air channel 21 is formed by respective internal spaces of the suction-side flange 13, discharge-side flange 15, and cylindrical portion 17. The air channel 21 has openings 19a and 19b respectively located on either side thereof. An inside surface of the air channel 21 is formed of an inner peripheral surface 23 of the cylindrical portion, and tapered surfaces 25 and 26 that are continuous with the inner peripheral surface 23 and extend in a radially outward direction of the axial-flow fan. Stationary blades 28 are integrally formed with tapered surface 26 that is formed inside the discharge-side flange 15.

The motor case 5 includes a bottom wall portion 27, a peripheral wall portion 29, and a bearing supporting cylindrical portion 31. The bottom wall portion 27 is located on a side of the one opening 19a. The peripheral wall portion 29 is formed continuously with the bottom wall portion 27 and extends toward the other opening 19b. The bearing supporting cylindrical portion 31 is provided at the bottom wall portion 27 and extends toward the other opening 19b. Inside the bearing supporting cylindrical portion 31, two bearings 32 that support the rotary shaft 37 are disposed. The fan housing 3, the motor case 5, and the peripheral wall portion 29 are connected by four webs 33. The fan housing 3, the motor case 5, and the four webs 33 are integrally formed of a synthetic resin material. Each of outside end portions of the four webs 33 is integrally connected to the discharge-side flange 15 at a position which is closer to a corner of the discharge-side flange 15 than the central position of a corresponding side of the discharge-side flange 15. Then, positions where inside end portions of the webs 33 are connected to the motor case are defined so that a virtual straight line that passes through the outside and inside end portions of each web 33 may not pass through the center of the motor case and that the angle formed between respective virtual straight lines of adjacent two webs may be 90 degrees.

In this embodiment, when an outside diameter of the motor case 5 is defined as Rm and a minimum inside diameter of the air channel 21 as Rmin, shapes and dimensions of the motor case 5 and the fan housing 3 are defined so that the ratio of Rm/Rmin may take a value of 35% to 55%.

The impeller 7 includes a cup-like blade fixing member 35 and seven blades 36 mounted onto the blade fixing member 35. The impeller 7 is disposed within the air channel 21 of the fan housing 3. The blade fixing member 35 is fixed to one end of the rotary shaft 37 via an annular member 34 formed of brass.

Inside the blade fixing member 35, an annular magnet fixing ring member 38, which is formed of a magnetically permeable material, is fixed. Then, a plurality of rotor magnetic poles 39 constituted from a plurality of permanent magnets, are fixed to an inner peripheral portion of the magnet fixing ring member 38 so that the rotor magnetic poles 39 are arranged in a circumferential direction of the rotary shaft 37. In the present invention, the rotor 9 includes the rotary shaft 37, blade fixing member 35, magnet fixing ring member 38, and rotor magnetic poles 39. Thus, the impeller 7 is fixed outside the rotor 9.

The stator 11 includes a stator core 41 and a plurality of exciting windings 43. The stator core 41 is formed by lamination of a plurality of electromagnetic steel plates in the axial direction of the rotary shaft 37. The stator core 41 includes a plurality of stator magnetic poles 41a that face the rotor magnetic poles 39 in a radial direction of the rotary shaft 37. The exciting windings 43 are respectively wound around the stator magnetic poles 41a . The stator core 41 is formed with a through hole 41b into which the bearing supporting cylindrical portion 31 is fitted. The stator 11 is fixed to the bearing supporting cylindrical portion 31 with the bearing supporting cylindrical portion 31 being fitted into the through hole 41b. The exciting windings 43 are connected to a circuit substrate 45 fixed within the motor case 5. A circuit for supplying exciting current to the exciting windings 43 is mounted on the circuit substrate 45.

In this embodiment, when a thickness of the stator core 41 is defined to be TSt as measured in parallel with the axial direction of the rotary shaft 37 and a thickness of the fan housing 3 is defined to be TFr as measured in parallel with the axial direction, shapes and dimensions of the stator 11 and the fan housing 3 are defined so that the ratio of TSt/TFr may take a value of 8% to 25%. Further, when a thickness of the rotor magnetic poles 39 of the rotor 9 is defined to be TMg as measured in parallel with the axial direction, shapes and dimensions of the rotor 9 and the stator 11 are defined so that the ratio of TSt/TMg may take a value of 40% to 70%. In the axis-flow fan of this embodiment, among a plurality of frequency components included in vibration to be carried to the fan housing 3 when the rotor 9 is rotated, an over-all value of a plurality of frequency components (cogging torque frequency components) caused by cogging torque becomes smaller than an over-all value of a plurality of frequency components (unbalance frequency components) caused by an unbalance of the rotor, over an entire speed range (an entire range of planned number of revolutions or rotational speeds) including low-speed and high-speed rotation regions.

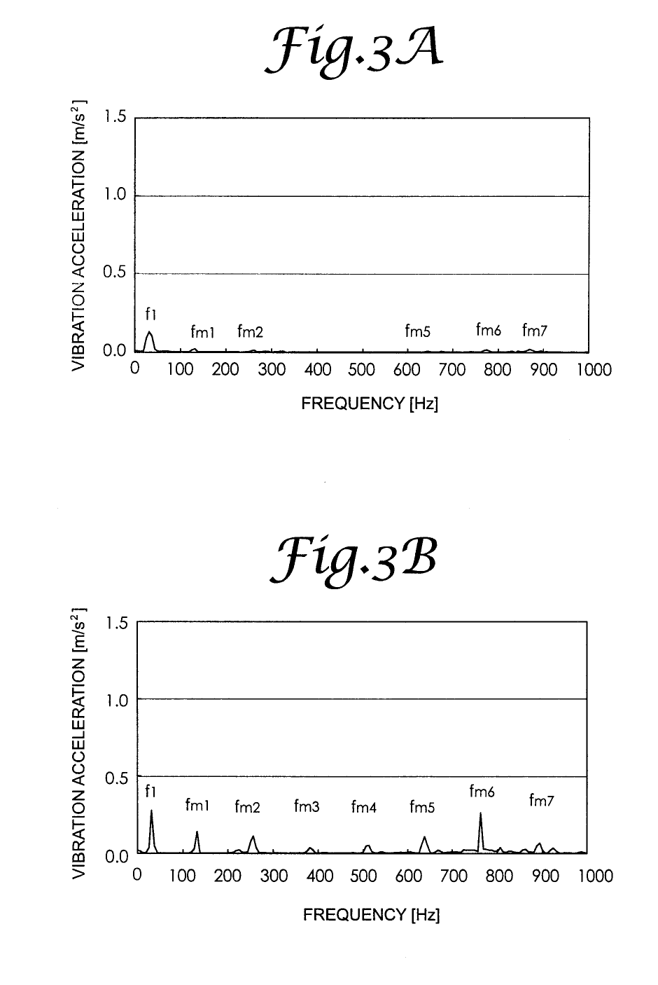

Next, the axial-flow fan of this embodiment and an axial-flow fan of a comparative example were rotated, and a relationship between a frequency and acceleration of vibration was studied in respect of both axial-flow fans. FIGS. 3A and 3B show results of measurement when the axial-flow fan of this embodiment and the axial-flow fan of the comparative example were rotated at a low speed of 1,900 rpm. In the axial-flow fan of this embodiment that was used in the test, the ratio of TSt/TFr was 20%, the ratio of TSt/TMg was 67%, and the ratio of Rm/Rmin was 45%. In the axial-flow fan of the comparative example that was used in the test, the ratio of TSt/TFr was 28%, the ratio of TSt/TMg was 72%, and the ratio of Rm/Rmin was 56%. In respect of aspects other than these ratios, the axial-flow fan of the comparative example has the same structure as the axial-flow fan of this embodiment.

Referring to FIGS. 3A and 3B, fₙ (where n is an integer, for example, f₁) indicates a frequency spectrum of an unbalance frequency component, and fₘₙ (where n is an integer, for example, fₘ₁) indicates a frequency spectrum of a cogging torque frequency component. It is found from FIG. 3A that, in the axial-flow fan of this embodiment, among frequency components included in the vibration that was carried to the fan housing when the rotor was rotated at the low speed, the ratio of the over-all value (a mean square sum resulting from a Hanning window (Hf=2/3)) of cogging torque components, obtained by the following expression, to the total over-all value (a sum of the over-all value of cogging torque frequency components and the over-all value of unbalance frequency components) was 13%. In the following expression, a synthesized value of frequency spectra (vibration accelerations) of the cogging torque frequency components is obtained as the over-all value. Accordingly, fₙ in the following expression indicates a vibration acceleration value of the frequency component in the frequency spectrum fₙ. The following expression obtains the mean square sum of vibration acceleration values. In the following expression, (2/3) is a coefficient of the Hanning Window (Hf).

O.A [f(m*n)]=\sqrt{(f₁²+f₂²+f₃²+. . . fₘₙ²)·(2/3)} [Expression 1]

The ratio of the over-all value (a mean square sum resulting from the Hanning Window (Hf=2/3)) of unbalance frequency components, obtained by the following expression, to the total over-all value was 87%.

O.A[f(n)]=\sqrt{(f₁²+f₂²+f₃²+. . . +fₙ²)·(2/3)} [Expression 2]

It is found from FIG. 3B that in the axial-flow fan of the comparative example, the ratio of the over-all value of cogging torque frequency components to the total over-all value was 66%, and the ratio of the over-all value of unbalance frequency components to the total over-all value was 34%.

From these measurement results, it can be seen that when the axial-flow fan of the comparative example is rotated at the low speed, the over-all value of cogging torque frequency components becomes larger than the over-all value of unbalance frequency components. It can also be seen that when the axial-flow fan of this embodiment is rotated at the low speed, the over-all value of cogging torque frequency components becomes smaller than the over-all value of unbalance frequency components. When FIGS. 3A is compared with FIG. 3B, it can be seen that, in the axial-flow fan of this embodiment, the over-all value of cogging torque frequency components becomes smaller than the over-all value of unbalance frequency components, and consequently the axial-flow fan may generally restrain vibration more than the axial-flow fan of the comparative example.

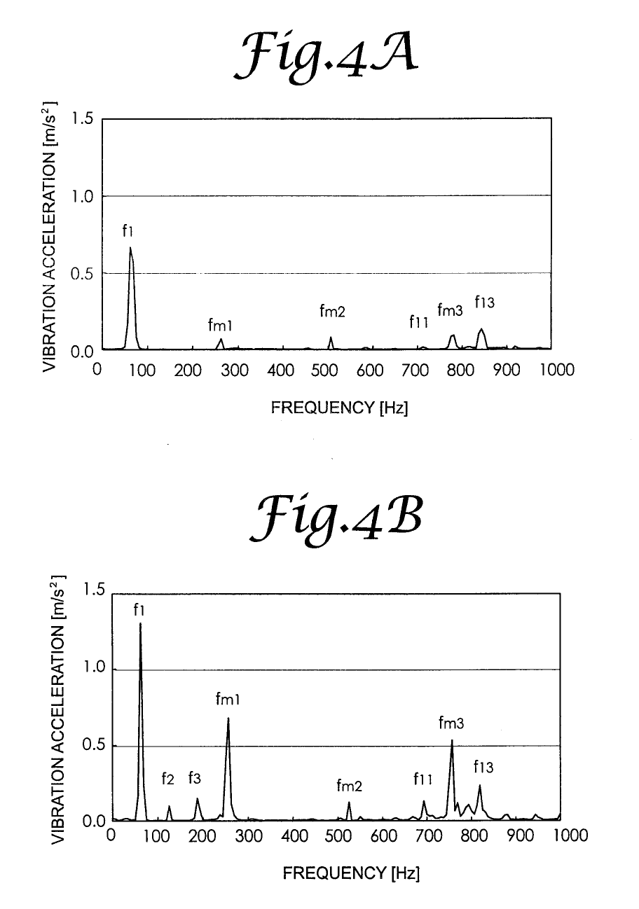

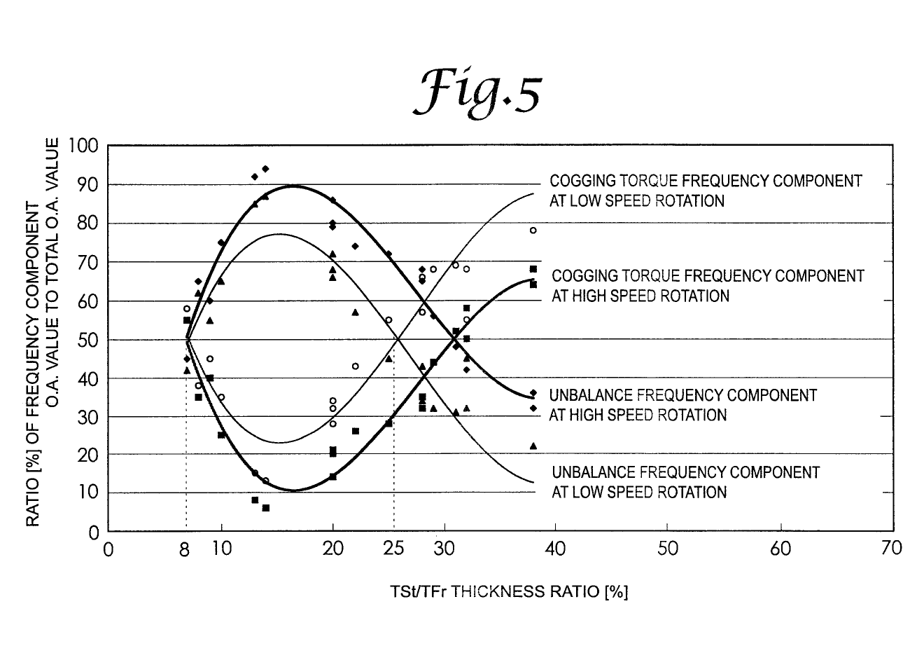

FIGS. 4A and 4B show results of measurement when the axial-flow fan of this embodiment and the axial-flow fan of the comparative example were rotated at a high speed of 3,800 rpm, respectively. It is found from FIG. 4A that, in the axial-flow fan of this embodiment, among a plurality of frequency components included in vibration that was carried to the fan housing when the rotor was rotated at the high speed, the ratio of the over-all value of cogging torque frequency components, obtained by the above-mentioned expression, to the total over-all value was 6%, and the ratio of the over-all value of unbalance frequency components, obtained by the above-mentioned expression, to the total over-all value was 94%. It is found from FIG. 4B that in the axial-flow fan of the comparative example, among a plurality of frequency components included in vibration that was carried to the fan housing when the rotor was rotated at the high speed, the ratio of the over-all value of cogging torque frequency components, obtained by the above-mentioned expression, to the total over-all value was 35%, and the ratio of the over-all value of unbalance frequency components, obtained by the above-mentioned expression, to the total over-all value was 65%.

Next, the ratio of TSt/TFr, namely, the ratio of the thickness TSt of the stator core 41 measured in parallel with the axial direction of the rotary shaft 37 to the thickness TFr of the fan housing 3 in parallel with the axial direction of the rotary shaft 37 was varied. Then, the following relationships were studied: relationships between the ratio of TSt/TFr and the ratio of the over-all value of cogging torque frequency components to the total over-all value, and relationships between the ratio of TSt/TFr and the ratio of the over-all value of unbalance frequency components to the total over-all value when the axial-flow fan was rotated at a low speed of 1,900 rpm. The following relationships were also studied: relationships between the ratio of TSt/TFr and the ratio of the over-all value of cogging torque frequency components to the total over-all value, and relationships between the ratio of TSt/TFr and the ratio of the over-all value of unbalance frequency components to the total over-all value when the axial-flow fan was rotated at a high speed of 3,800 rpm. FIG. 5 shows results of measurements of these relationships. It can be seen from FIG. 5 that, when the axial-flow fan is rotated at a low speed and the ratio of TSt/TFr is from 8% to 25%, an over-all value of cogging torque frequency components becomes smaller than an over-all value of unbalance frequency components, namely, the ratio of the over-all value of cogging torque frequency component; to the total over-all value becomes smaller than the ratio of the over-all value of unbalance frequency components to the total over-all value. It has been confirmed that when the ratio of TSt/TFr is below 8%, an output of the motor decreases, which will lead to augmented power consumption, increased vibration, and starting failure of the motor. Accordingly, the lower limit is 8%. It can also be seen that, when the axial-flow fan is rotated at a high speed and the ratio of TSt/TFr is equal to or less than 35%, an over-all value of cogging torque frequency components becomes smaller than an over-all value of unbalance frequency components, namely, the ratio of the over-all value of cogging torque frequency components to the total over-all value becomes smaller than the ratio of the over-all value of unbalance frequency components to the total over-all value.

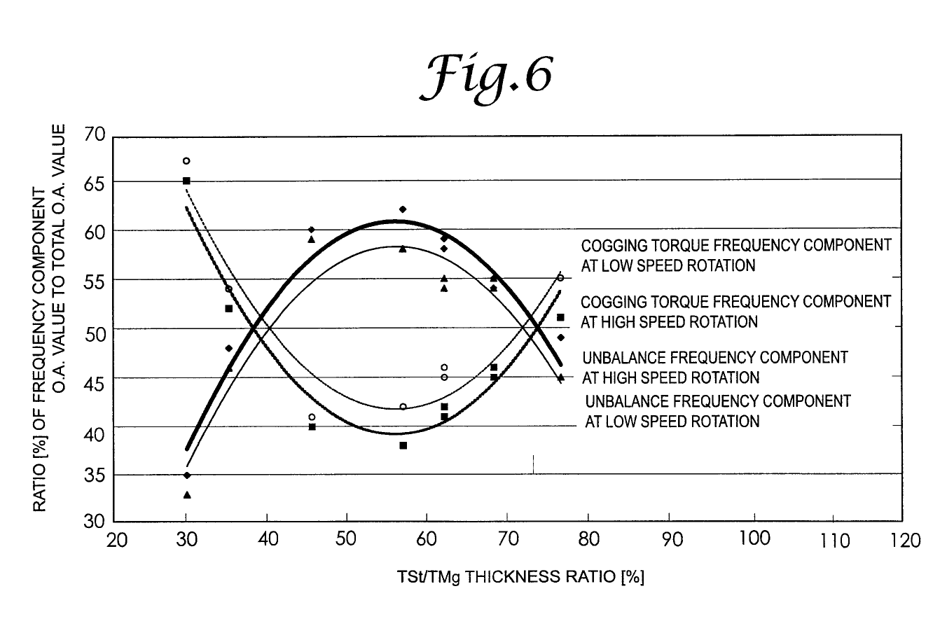

Next, the ratio of TSt/TMg, namely, the ratio of thickness TSt of the stator core 41 measured in parallel with the axial direction of the rotary shaft 37 to thickness TMg of the rotor magnetic pole 39 of the rotor 9 measured in parallel with the axial direction was varied. Then, the following relationships were studied: relationships between the ratio of TSt/TMg and the ratio of the over-all value of cogging torque frequency components to the total over-all value, and relationships between the ratio of TSt/TMg and the ratio of the over-all value of unbalance frequency components to the total over-all value when the axial-flow fan was rotated at the low speed of 1,900 rpm. The following relationships were also studied: relationships between the ratio of TSt/TMg and the ratio of the over-all value of cogging torque frequency components to the total over-all value, and relationships between the ratio of TSt/TMg and the ratio of the over-all value of unbalance frequency components to the total over-all value when the axial-flow fan was rotated at the high speed of 3,800 rpm. FIG. 6 shows results of measurements of these relationships. It can be seen from FIG. 6 that, when the axial-flow fan is rotated at a low speed and the ratio of TSt/TMg is from 40% to 70%, the over-all value of cogging torque frequency components becomes smaller than the over-all value of unbalance frequency components, namely, the ratio of the over-all value of cogging torque frequency components to the total over-all value becomes smaller than the ratio of the over-all value of unbalance frequency components to the total over-all value.

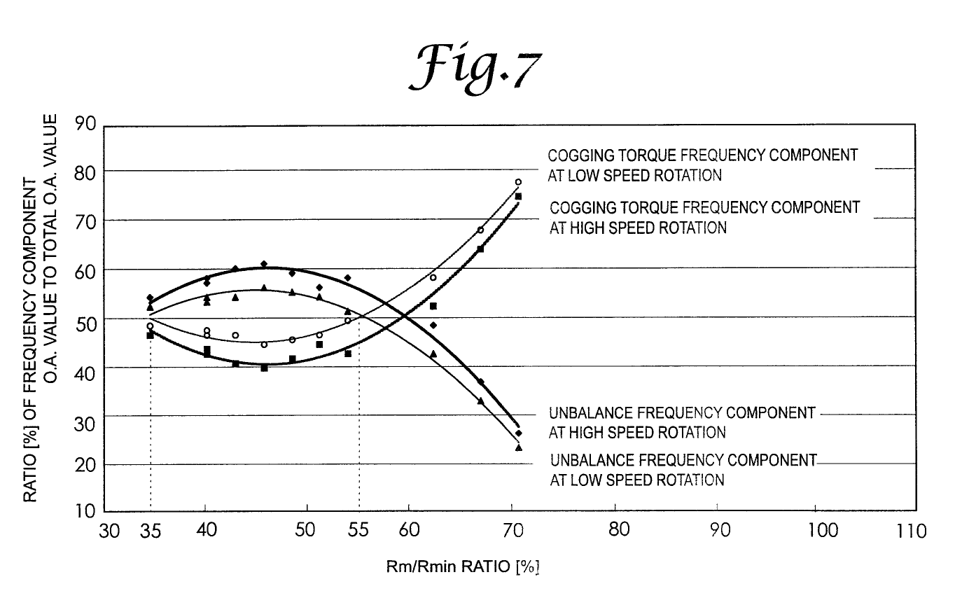

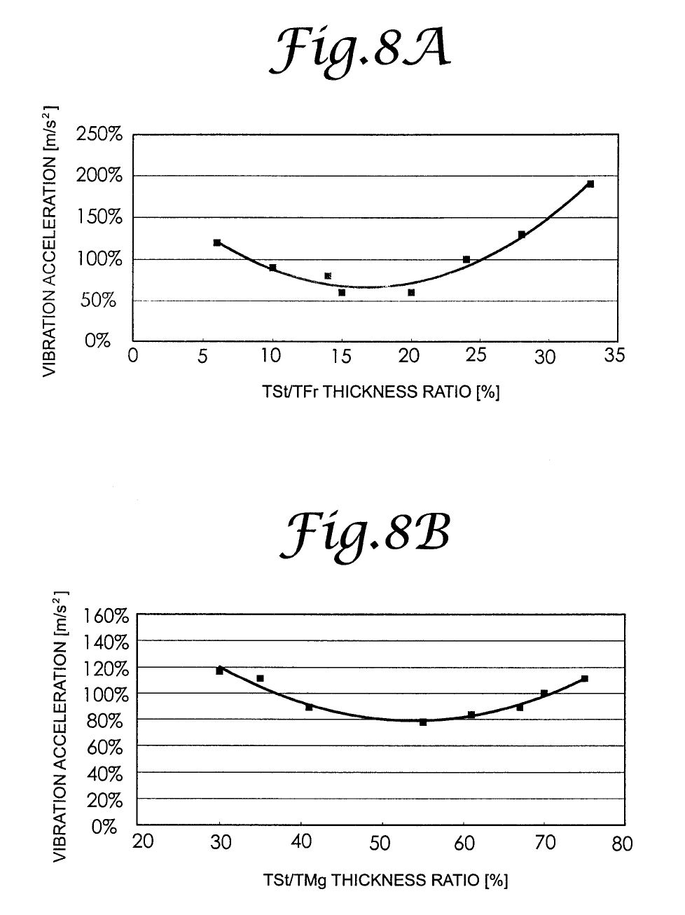

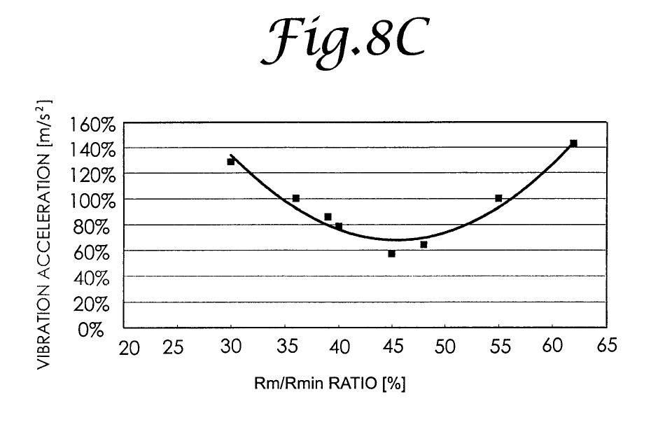

Next, the ratio of Rm/Rmin, namely, the ratio of an outside diameter Rm of the motor case 5 to the minimum inside diameter Rmin of the air channel 21 was varied. Then, the following relationships were studied: relationships between the ratio of Rm/Rmin and the ratio of the over-all value of cogging torque frequency components to the total over-all value, and relationships between the ratio of Rm/Rmin and the ratio of the over-all value of unbalance frequency components to the total over-all value when the axial-flow fan was rotated at the low speed of 1,900 rpm. The following relationships were also studied: relationships between the ratio of Rm/Rmin and the ratio of the over-all value of cogging torque frequency components to the total over-all value, and relationships between the ratio of Rm/Rmin and the ratio of the over-all value of unbalance frequency components to the total over-all value when the axial-flow fan was rotated at the high speed of 3,800 rpm. FIG. 7 shows results of measurements of these relationships. It can be seen from FIG. 7 that, when the axial-flow fan is rotated at a low speed and the ratio of Rm/Rmin is from 32% to 55%, an over-all value of cogging torque frequency components becomes smaller than an over-all value of unbalance frequency components, namely, the ratio of the over-all value of cogging torque frequency components to the total over-all value becomes smaller than the ratio of the over-all value of unbalance frequency components to the total over-all value. Taking account of vibration acceleration shown in FIG. 8C, which will be described later, the preferred range of Rm/Rmin is 35% to 55%.

FIGS. 8A, 8B, and 8C respectively show measurement results of relationships of TSt/TFr, TSt/TMg, and Rm/Rmin ratios with vibration acceleration of the fan housing. As is known from these figures, the vibration acceleration of the fan housing is less than 100% in the preferred numeric ranges of TSt/TFr, TSt/TMg, and Rm/Rmin, which indicates that vibration is restrained from being carried to the fan housing. In FIGS. 8A to 8c, vibration acceleration represented as an axis of ordinate is measured on an assumption that vibration acceleration for the axial-flow fan of the comparative example is 100%.

While the preferred embodiment of the invention has been described with a certain degree of particularity with reference to the drawings, obvious modifications and variations are possible in light of the above teachings. It is therefore to be understood that within the scope of the appended claims, the invention may be practiced other than as specifically described.

What is claimed is:

1. An axial-flow fan comprising:
a fan housing including an air channel having one opening and the other opening;
an impeller disposed inside the air channel and including a plurality of blades;
a rotor including a rotary shaft and a plurality of rotor magnetic poles constituted from permanent magnets, the rotor magnetic poles being disposed in a circumferential direction of the rotary shaft;
a stator including a stator core having a plurality of stator magnetic poles, and exciting windings respectively wound around the stator magnetic poles, the stator magnetic poles facing the rotor magnetic poles in a radial direction of the rotary shaft;
a motor case including a bottom wall portion located on a side of the one opening, a peripheral wall portion formed continuously with the bottom wall portion and extending toward the other opening, and a bearing supporting cylindrical portion provided at the bottom wall portion and extending toward the other opening; and
bearings that support the rotary shaft, being disposed inside the bearing supporting cylindrical portion,
the impeller being fixed to the rotor;
the stator core being formed with a through hole into which the bearing supporting cylindrical portion is fitted,
the stator being fixed to the bearing supporting cylindrical portion with the bearing supporting cylindrical portion fitted into the through hole, wherein
the rotor, the stator, the impeller, the fan housing, and the motor case are constituted so that, among a plurality of frequency components included in vibration which is carried to the fan housing when the rotor is rotated, an over-all value of a plurality of frequency components caused by cogging torque becomes smaller than an over-all value of a plurality of frequency components caused by unbalance of the rotor, over an entire speed range of the axial-flow fan.

2. The axial-flow fan according to claim 1, wherein
when a thickness of the fan housing is defined to be TFr as measured in a direction parallel to an axial direction of the rotary shaft, and a thickness of the stator core is defined to be TSt as measured in the direction parallel to the axial direction, a ratio of TSt/TFr takes a value of 8% to 25%.

3. The axial-flow fan according to claim 2, wherein
when a thickness of the rotor magnetic pole of the rotor is defined to be TMg as measured in the direction parallel to the axial direction, a ratio of TSt/TMg takes a value of 40% to 70%.

4. The axial-flow fan according to claim 3, wherein the fan housing and the peripheral wall portion are connected by four webs; and
when a minimum inside diameter of the air channel is defined to be Rmin and an outside diameter of the motor case is defined to be Rm, a ratio of Rm/Rmin takes a value of 35% to 55%.

5. The axial-flow fan according to claim 1, wherein
the bearings are constituted from a pair of ball bearings disposed inside the bearing supporting cylindrical portion, the ball bearings in the pair being arranged at an interval in the axial direction; and
the stator core and the pair of ball bearings are arranged so that a mounting position of the stator core on the bearing supporting cylindrical portion is located between positions of the pair of ball bearings disposed inside the bearing supporting cylindrical portion.
